(19) United States
(12) Patent Application Publication
(10) Pub. No.: US 2025/0197114 A1
(43) Pub. Date: Jun. 19, 2025

(54) An unmanned shuttle for load handling in a warehouse

(71) Applicant: Cleveron AS, Viljandi (EE)

(72) Inventors: Tarmo Must, Viljandi (EE); Jonar Ilves, Viljandi (EE); Mart Leib, Viljandi (EE); Rainer Binsol, Viljandi (EE)

(21) Appl. No.: 18/974,889

(22) Filed: Dec. 10, 2024

Related U.S. Application Data
(60) Provisional application No. 63/610,765, filed on Dec. 15, 2023.

(51) Int. Cl. B65G 1/04

(52) U.S. Cl. CPC B65G 1/0492

(57) ABSTRACT

An unmanned warehouse shuttle with telescopic arms capable of handling various sizes of packages and moving them fast and stably on rails within a warehouse system. The system provides flexibility in that a distance between the side compartments is adjustable and that the distance between the arms is adjustable. A unique extension system for the extendable arms is disclosed where the arms comprise two parts and are configured to extend and provide an extension length that is more than twice the depth of the platform of the shuttle.

### PRIORITY

This application claims priority to U.S. Provisional Application No. 63/610,765 which was filed on Dec. 15, 2023 and the contents of which is incorporated herein by reference.

### FIELD OF INVENTION

This invention relates to load handling systems, especially in a warehouse setting, even more specifically to unmanned warehouse shuttle with telescopic arms.

### BACKGROUND OF THE INVENTION

There is a large number of disclosures for various kinds of load handling systems in a warehouse setting. A general feature of the disclosed system includes a shuttle device moving between the warehouse shelves and reaching to pick packages, or items from the shelf to transport the package or items to a destination. A problem that many of the disclosures address is either how to load more than one package onto the shuttle at the very same time, or how to enable picking packages of different sizes onto the shuttle.

A few examples of solutions how to adjust the distance between gripping arms and the width of the loading area of a shuttle device are:

U.S. Pat. No. 10,414,587 discloses a transporting apparatus for a single-level rack having a first and a second chassis each having an extendable arm, and a storage region between the chassis halves. The storage region can be varied by varying the spacing between the arm together with lateral supporting plates.

US 10,850,42 discloses a device for gripping a load by gripping arms, and the width between the arms is varied by locking one chassis half and actuating movement of the other chassis half.

A mechanism of extending the gripping arms is addressed for example in the following publications:

U.S. Pat. No. 10,894,663 discloses an automated storage retrieval system where telescopic arm assemblies include movable pusher elements and linearly moving tabs on the arms so as to change a distance between the tab and a finger to fit items of different size on the system. The telescopic arm is constructed to have multiple layers of extending and retracting members sliding in series within each other via belt and pulley arrangement in each of the telescoping members.

U.S. Pat. No. 9,522,781 discloses a device for gripping a load, wherein the system has chassis elements that are moving in relation to each other so as to change the width between gripping arms that are attached to the chassis portions and that way adopt to loading items of different widths. Drive assemblies including a rotatable drum and a cable extend and retract the telescopic arms.

In US 18/218,376 the Applicant of the current application discloses a telescopic arm assembly for a warehouse shuttle, where the arms comprise three parts of equal length and where the first part is stationary while the two parts are configured to extend. The second part extends almost half of its length over an edge of the platform between the arms and the third part extends more than half of its length over the distal end of the second part. The system thus allows telescopic arms that have an extension length more than twice of the depth of the platform. The extension of the arms functions via multiple pinions and toothed racks.

Thus, there are solutions providing various mechanisms for warehouse shuttles having adjustable width and gripping arms for reaching to different depths in the warehouse shelf. Due to the fact that automated warehouses are getting more and more popular, there is also a need for shuttles having simpler and more stable structures while not compromising the ability of adjust the width of the platform between the arms and the extension length of the arms.

### SUMMARY OF THE INVENTION

The current disclosure therefore provides a shuttle having an adjustable width of the loading area between extendable arms that comprise two extendable parts that allow the arms to extend more than twice the width of the platform, and wherein the mechanism of the extension is simple and steady and the arms require no movable levers to move the crate, thereby ensuring less problems in the operation and less elements that would need to have service or which would need to be changed.

Accordingly, it is an object of this invention to provide an unmanned shuttle for automated warehouse systems configured to move along warehouse rail, the shuttle comprising: a first and a second side compartment (102), each having at least an inner wall (102a) and two end walls (102b),
the first side compartment being a motor comprising compartment and housing an arms drive motor (201), a compartment drive motor (214), and a wheel drive motor (104),
   the first and the second side compartments being attached to each other via a splined shaft (202) having a first end connected to the compartment drive motor (214) via a fixed chain sprocket (217) attached to a first obround chain guide (206) attached to a bottom part of the inner wall (102a) of the first side compartment (102), and a second end connected to a splined hub attached to a sliding chain sprocket (205) attached to a second obround chain guide (206) attached to a bottom part of the inner wall of the second side compartment, wherein the splined shaft (202) is configured to be rotated by the compartment drive motor (214) and the sliding chain sprocket (205) is configured to simultaneously slide along the splined shaft, while the fixed chain sprocket (217) at the other end of the splined shaft is configured to turn but not slide;
the inner wall of each side compartment comprising a stationary horizontal toothed rack (208);
   two telescopic arms (200) configured to extend in synchrony to two opposite directions;
each telescopic arm comprising a first part (203) and a second part (204),
   the first part comprising a toothed rack (207) along its lower edge and an obround chain drive system (209) mounted on its upper edge at a middle of the length of the first part, said toothed rack being in contact with the first or the second obround chain guide (206) attached onto the bottom part of the inner wall of the first or second side compartment respectively, and the first part being configured to extend upon moving the chain around the chain guide (206) via turning the splined shaft (202),
   the second part (204) comprising a toothed rack on its upper edge and the toothed rack (218) being in contact with the obround chain system (209) on the upper edge of the first part, and the second part configured to extend upon moving a chain around the chain guide of the obround chain system (209) upon extending movement of the first part,
      wherein at least one of the side compartments comprises a horizontal inward extending crate guide surface (112) configured to provide support for a crate (111) positioned on a loading space (106) between the first and second side compartments (102),
      wherein a distance between the first and second side compartments is adjustable via a ball or trapezoidal screw (210) connecting the compartments to each other, and the ball or trapezoidal screw configured to be turned by the compartment drive motor (214),
      and wherein the shuttle (100) has at least one wheel (103) in each end wall (102b) of the first and the second compartments (102) and the wheels of the first compartment are connected with a driveshaft (105) and the driveshaft is driven by the wheel drive motor (104) with a belt (108) housed inside the first side compartment.

Another object of the invention is to provide a method to transport and store parcels of different sized in an automated warehouse system wherein the method comprises providing the shuttle system as describe above, and depending on the size of a parcel to be retrieved by the telescopic arms and transported on the shuttle, the distance between the telescopic arms is adjusted by moving the side compartments closer or further away from each other via the compartment drive motor turning the ball or trapezoidal screw, and by adjusting the extension length of the telescopic arms by the arms drive motor controlling rotation of the splined shaft and thereby extending movement of the first part of the telescopic arms which causes extending movement of the second part.

### BRIEF DESCRIPTION OF THE DRAWINGS

FIG. 1 is a perspective view of a shuttle 100 holding a crate 111. The figure shows two side compartments 102 and loading area for the crate on platform 101 between the compartments. The crate 111 is on the platform. The figure shows two telescopic arms 200 in retracted position. Support rollers 107 and wheels 103 of the shuttle are shown. Inside of one side compartment there is shown a driveshaft 105, and a belt 108 for driving the wheels.

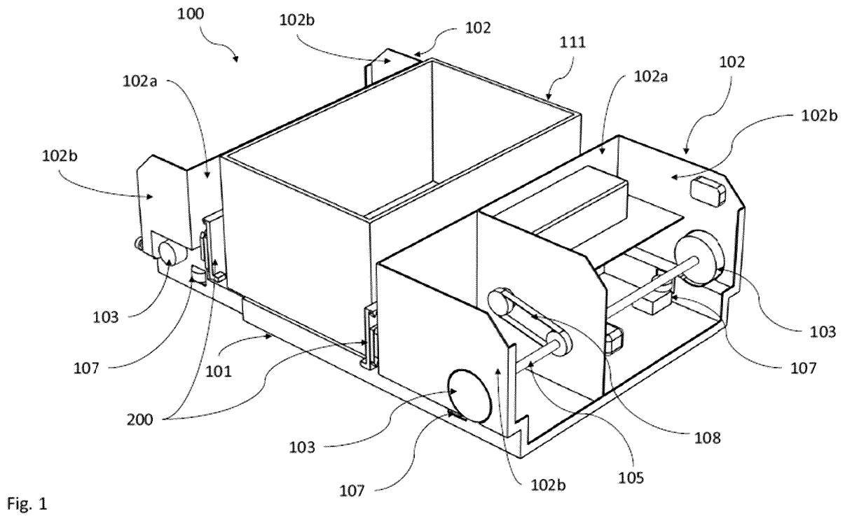

FIG. 2 illustrates shelving structures 301 and aisles 300 of an automated warehouse where the shuttle moves along the rail structures 302 and transports the crates along the aisles and moves the crates on and off the shelving structures.

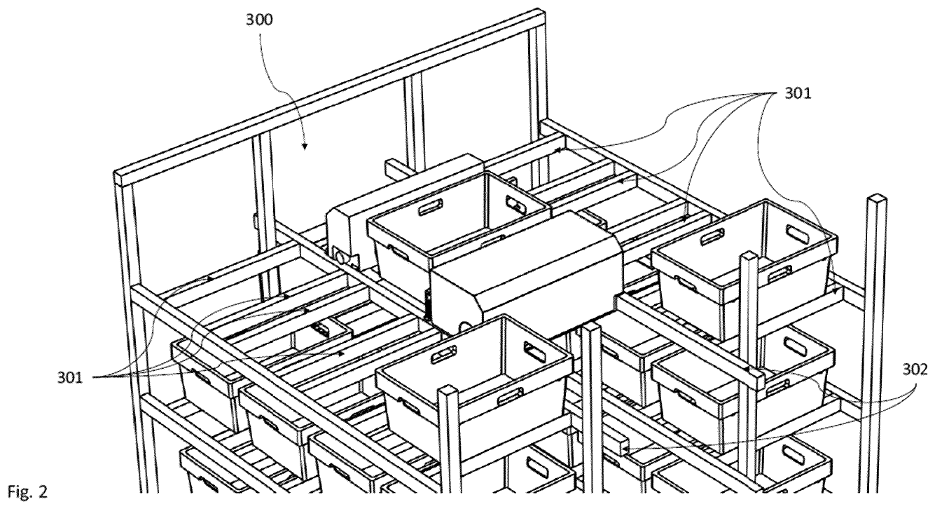

FIG. 3 illustrates movement of the two telescopic arms 200. The telescopic arms are capable of extending into opposite directions shown with long arrows. The telescopic arms 200 are also configured to move toward and away from each other as shown with the short arrows. The extension length of the telescopic arms 200 is shown in the figure to be more than two times the width of the shuttle (x). The figure shows a sliding chain sprocket 205 and an obround chain guide (second obround guide) 206 that are part of the mechanism of extending/retracting the telescopic arms 200. The telescopic arms have a first and a second parts 203 and 204, respectively. The toothed rack 218 of the second part 204 is visible on an upper edge of one of the second part 204 of one of the two telescopic arms in the figure. The toothed rack 218 of the first part 203 is visible in one of the two telescopic arms on the lower edge of the first part.

FIG. 4 is an illustration of an inner side of a side compartment 102 and the telescopic arm mounted on the compartment. The telescopic arm is shown to have a first part 203 and a second part 204. The figure shows a horizontal stationary toothed rack 208 mounted onto the inner wall 102a. Obround chain drive system 209 is mounted on the upper edge of the first part 203 at about its middle. The toothed rack 218 of the second part 204 is on the upper edge of the second part. On the lower edge of the first part 203 there is visible the toothed rack 207 of the first part. Both ends of the second part 204 are shown to have grippers 215 at their lower edges. The figure also shows the crate guide surface 112 attached to the side compartment. Underneath the crate guide surface 112 there is shown a ball screw or trapezoidal screw 210, and the splined shaft 202. Obround chain guide (second obround guide) 206 is shown to be in connection with the toothed rack 207 of the first part. A chain sprocket is illustrated as element 217. The figure further shows the linear bearings 211/212 underneath the crate guide surface 112.

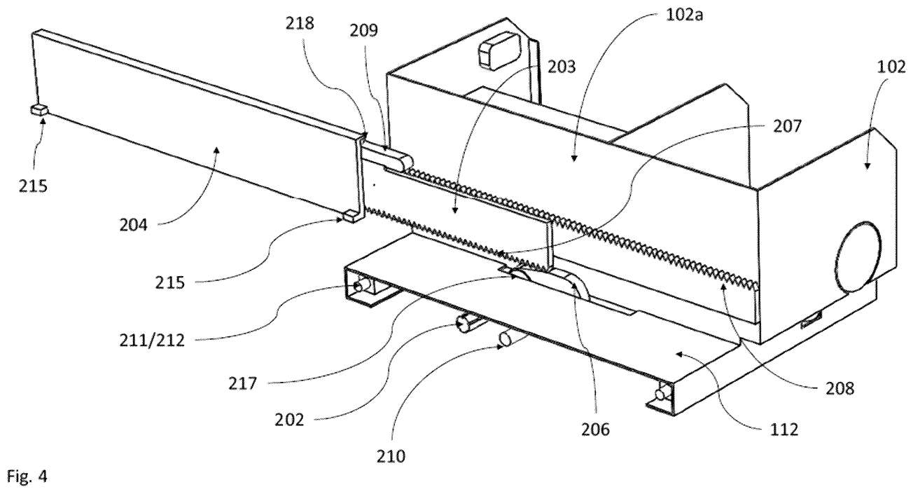

FIG. 5 is an illustration showing inside of the motor comprising compartment, only one of the compartments include the motor elements. The figure shows belt 108, a board energy source 109 and charging interface 110. The wheel drive motor 104 of the arms is shown as well as the arms drive motor 201 and compartment drive motor 214. Element 106 illustrates the loading space in between the compartments.

FIG. 6 illustrates the inside of the compartment that does not have the motor elements. The figure shows the splined shaft 202 and bearing housing 216 located underneath the crate guide surface 112 (shown in FIG. 4). The figure shows also a ball or trapezoidal screw 210 and a screw nut 213.

FIG. 7 is a side view of a compartment. The figure shows a wheel 103 and a support roller 107 on the side compartment 102. Splined shaft 202 is shown lengthwise in this figure. Sliding chain sprocket 205 and an obround chain guide (second obround guide) 206 are shown here. A gripper 215 is shown to be mounted on the lower edge at the end of second part 204 of a telescopic arm 200. Toothed rack 218 of the second part 204 is shown. First part 203 of the arm is shown and a toothed rack of the first part of the arm is shown as 207. Stationary toothed racks 208 is shown attached to inner wall 102a of the compartment and an obround chain drive system is shown as 209.

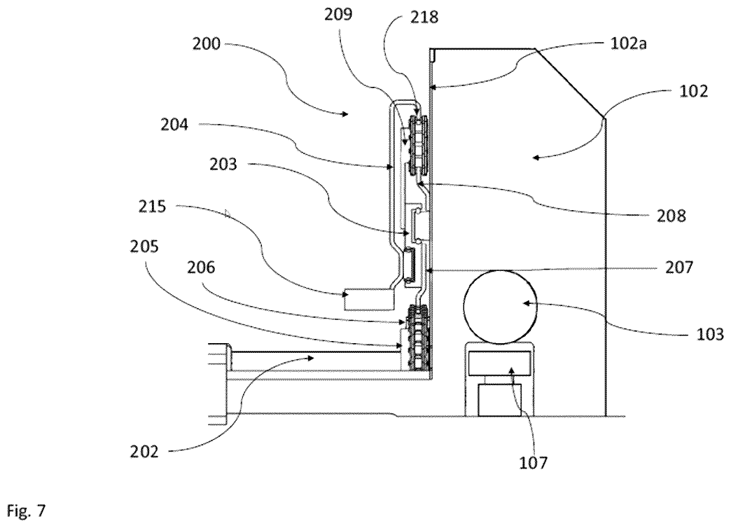

FIG. 8 is an even more detailed illustration of an inner side of a side compartment 102 and the telescopic arm mounted on the compartment. Shown is the moving compartment of the shuttle. The telescopic arm is shown to have a first part 203 and a second part 204. The figure shows a horizontal stationary toothed rack 208 mounted onto the inner wall 102a. An obround chain drive system 209 is mounted on the upper edge of the first part 203 at about its middle. The toothed rack 218 of the second part 204 is on the upper edge of the second part. On the lower edge of the first part 203 there is visible the toothed rack 207 of the first part. At the end of the second part 204 is shown a gripper 215 at its lower edge. The figure also shows the crate guide surface 112 attached to the side compartment. Obround chain guide (second obround guide) 206 is shown to be in connection with the toothed rack 207 of the first part. A fixed chain sprocket is illustrated as element 217 connected to sliding chain sprocket (205) of a splined hub.

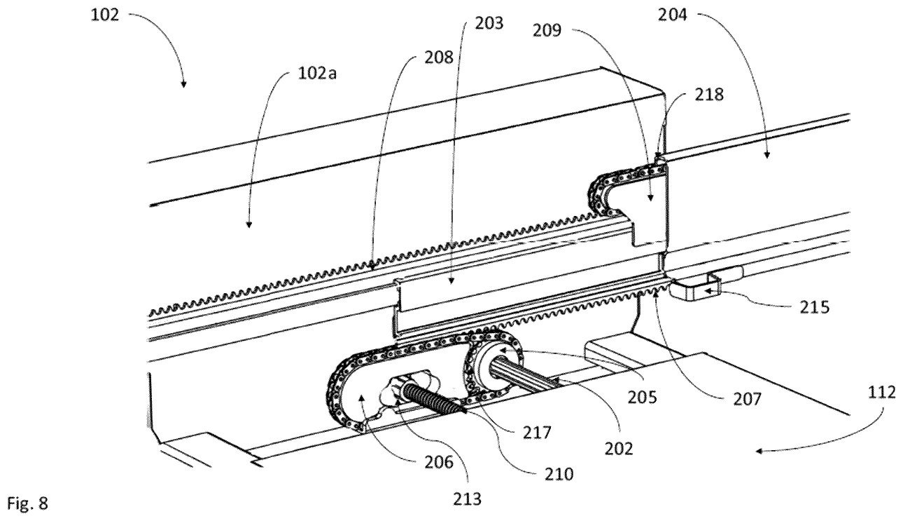

### DETAILED DESCRIPTION OF THE INVENTION

The shuttle of this disclosure comprises platform 101, two side compartments 102, two telescopic arms 200 mounted to the side compartments, and a loading space 106 formed in between of the side compartments to load a crate 111. The shuttle has an even number of wheels 103 such that half of the wheels are on one side and half of them on the other side of the shuttle. The wheels are preferably located on opposite sides of the side compartment 102. Preferably the shuttle has four wheels, two on each side. At least one of the wheels is driven by a wheel drive motor 104 located inside one of the side compartments, preferably in the motor comprising side compartment the two opposing drive wheels are connected by a driveshaft 105 and the drive shaft is driven by the wheel drive motor 104 with a belt 108.

The wheels 103 are configured to move the shuttle 100 along an aisle 300 of a warehouse structure between the shelving structures 301 on warehouse rail structures 302. The rail structures 302 are preferably created by forward protruding horizontal parts of the shelving structures protruding into the aisle between the shelving structures. The wheels 103 are preferably coated with polyurethane or similar wear resistant material.

In addition to the wheels 103, the shuttle 100 has an even number of support rollers 107 such that two sides of the platform 101 have an equal number of support rollers. The support rollers are preferably located on the platform underneath the wheels. These support rollers have rolling axles that are vertical and their purpose is to limit sideways movement of the shuttle while moving along the warehouse rail structure 302 along the aisle. The support rollers are also providing support during the loading and unloading of crates or items to and from the loading space of the shuttle. The support rollers are in contact with the same rail structure as the wheels 103, however, the support rollers contact the side of the warehouse rail structure while the wheels contact the top of the warehouse rail structure. Furthermore, the support rollers on one side are mounted on dampeners that keep the shuttle at a constant distance from the rail and smoothen out any deviation in the distance between the rails and keep support rollers on the other side pushed against the rail side.

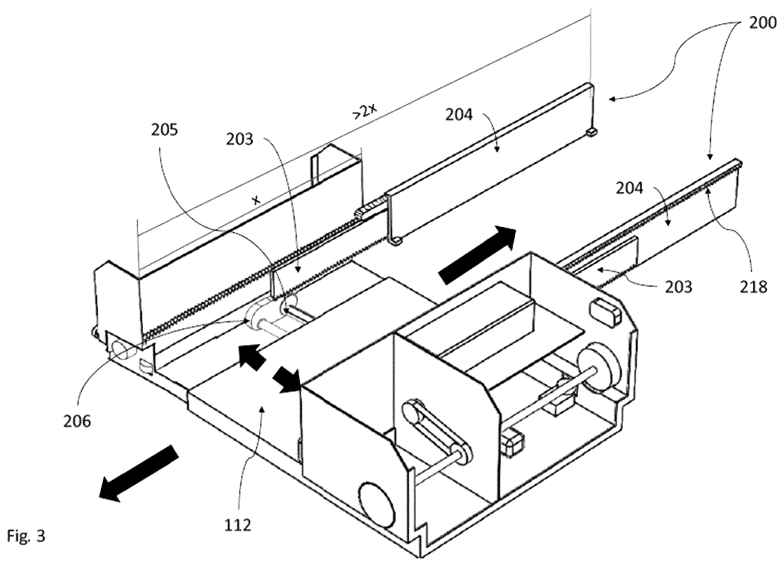

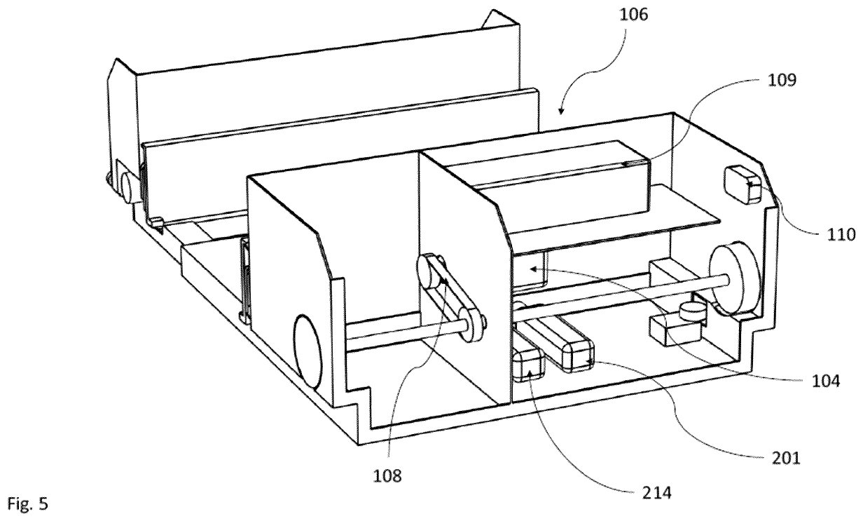

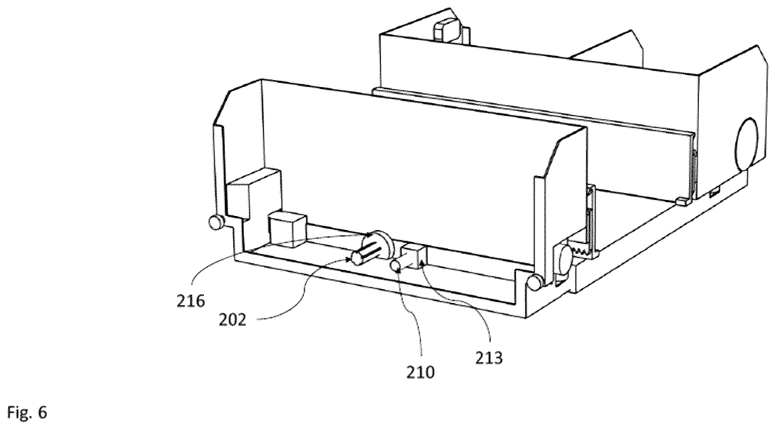

The shuttle is equipped with two telescopic arms 200. These arms are located on inner sides of the side compartments such that a loading area is formed in between inner walls 102a of the side compartments on top of the platform 101. By the term platform as used in this disclosure, it is meant the flat bottom area that is limited between the outer edges of the side compartments and front and the back edges of the shuttle. The platform may comprise parts of the bottom of the side compartments, and the crate guide surface 112. The platform has back and front edges beyond which the telescopic arms extend, and the distance between the back and front edges of the platform is referred to as the depth (x, in FIG. 3) of the platform. By width of the platform it is meant the distance between the inner walls 102a of the compartments. The telescopic arms move in synchrony with each other, and they are configured to extend to both directions perpendicularly against the moving direction of the shuttle. Both arms share one arms drive motor 201 which is located inside one of the side compartments (see FIG. 5). The arms drive motor 201 is connected to a splined shaft 202 (FIG. 6, 7) that drives both of the arms and protrudes the inner walls 102a of the side compartments 102.

The telescopic arms 200 are configured to extend in two directions such that the extension length of the arms in either direction is more than twice the depth (x) of the platform 101 (i.e. width of the shuttle). In the retracted position the arms have a length equal to the depth of the platform (width of the shuttle), but in fully extended position the length of the arm is more than twice the depth of the platform (width of the shuttle). This invention provides a unique solution to achieve this. This feature provides a system that can reach crates or packages stored deep in a shelving system, as well as very large packages. This feature also allows the shuttle to deposit two or more small packages on same slot in a shelving system; one deeper into the shelving and the other closer to shelf edge. To achieve this overextension, the telescopic arms comprise two parts having equal lengths:

The first part 203 is configured to move almost half of its length over the back and front edges of the platform and the second part 204 is configured to move more than half of its length over the distal end of the first part so that the distal end of the second part is further away from the edge of the platform than the entire length of the second part. The length of each of the first and second part of the arm is preferably the same as the depth of the platform. In order to provide a telescopic arm capable of such overextension, the system requires specific features enabling the extension in a stable manner. The structure and function of the telescopic arms is described below in more detail.

In a preferred embodiment the first 203 and the second 204 part extend towards the shelving structure and crates or packages that are located on the shelving structure 301. At middle of the compartments under the platform 101 there is a splined shaft 202 that extends from one compartment to another. One end of the shaft is connected to arms drive motor 201 located inside the motor comprising side compartment. The arms drive motor 201 is configured to turn the shaft. The other end of the splined shaft 202 is supported by a splined hub that has a sliding chain sprocket 205 attached to it. In turn this splined hub is mounted to the inner wall of one of the two compartments via a bearing housing 216. This means that the sliding chain sprocket 205 slides along the splined shaft while rotated by the splined shaft. This is necessary because the distance between the telescopic arms 200 is not constant and the arms are connected to the inner walls 102a of the compartments. In the other compartment the fixed chain sprocket 217 is fixed to the splined shaft in a way it can turn with the splined shaft, but it cannot move along the splined shaft. In this way the arms can be extended and contracted in any distance between them by only one motor.

The sliding chain sprocket 205 and the fixed chain sprocket 217 drive the chains traveling on the obround chain guide 206 located on the inner wall of each side compartment. In one end of the obround chain guide the chain is driven by the described sprocket and the rest of the way the chain moves along the chain guide.

On the top side of each of the two obround chain guides 206 the chain is in contact with a toothed rack 207 of the first part 203 of the corresponding telescopic arm. Thanks to the obround shape the distal end of the first part can travel past the centreline of the shuttle device.

Also mounted on the inner walls 102a of the compartments there are stationary toothed racks 208. These racks are fixedly attached to the sidewalls. In the middle of the first parts 203 of each telescopic arm there is an obround chain drive system 209 similar to the above-described system but without sprockets. A chain travels along the obround guide (preferably plastic). This chain drive system is in contact with the stationary toothed rack 208 from the bottom side that is attached to the side of the compartment and with a toothed rack 218 on the second part 204 from above. As the first part starts to move the chain on the upper chain drive is in contact with the stationary toothed rack 208 and moving toothed rack on the second part 218 so that the second parts starts to move at the same time.

The telescopic arms 200 use telescopic linear guides to make out most of the first part 203 and connect first and the second part 204 together and furthermore the first part to the inner wall of the side compartment. The linear guide is also used to mount the obround chain drive system 209 to the first part.

The telescopic arms 200 can also move toward and away of each other to change the distance between the arms. To achieve this movement both side compartments are connected with at least one ball screw or trapezoidal screw 210 mechanism from underneath the platform 101. One compartment has two linear bearings 211 that are mounted on linear rails 212 mounted on the other compartment underneath the platform, connecting the two compartments. One of the compartments also has a screw nut 213 that is mounted inside the compartment (FIG. 6.) and supports the screw 210 on this side of the platform. On one end of the screw there is a compartment drive motor 214 inside the motor comprising compartment that turns the screw (FIG. 5). This means that when the screw 210 is turned the compartments move closer to each other or further away from each other thereby providing means to adjust the width of the loading space 106 in between of the arms. The sideways movement of the telescopic arms 200 along with the movement of the side compartments 102 allows the telescopic arm to reach larger or smaller items on the shelf.

At least one of the compartments has a crate guide surface 112 attached to it. This surface supports the crate while it is on the loading space and provides reduction in sliding resistance while the crate is moved onto or off the platform 101.

At the distal ends of the second parts of the arms there are fixed grippers 215. These grippers protrude the inside surface of the second part 204. The grippers move past the crate along with the telescopic arm 200 while it is being extended to grab a crate. When the arms extend past the crate the position of the arm part is confirmed by an encoder of the compartment drive motor 214 and the extending motion will stop. The compartments along with arms will move some distance closer to each other (via turning of the screw 210 as described above) to minimize the crates movement from side to side during crate's moving and then the telescopic arms are retracted to pull the crate onto the platform. Also, the grippers are now positioned behind the crate as they are fixed to the telescopic arm. To move the crate back to the shelf or to the opposite side, the grippers are already at the back of the crate. The arms are extended towards the shelving structure and the crate is pushed back with them. To move the crate/parcel to the same side of the shelving structure the grippers are already at the back of the crate and the crate is pushed onto the shelf with them. The distance between the compartments along with arms mounted thereon is increased and the arms are retracted back to the platform leaving the crate behind.

The platform 101 is wireless, motors and electronics are powered by on board energy source 109. Energy storage unit is located in one of the side compartments 102. Platform moves to charging station to autonomously start charging via charging interface 110 when needed.

### LIST OF ELEMENT NUMBERS

100 shuttle
101 platform
102 side compartments
102a inner wall of the side compartment
103 wheels
104 wheel drive motor
105 driveshaft
106 loading space
107 support rollers
108 belt
109 board energy source
110 charging interface
111 crate
112 crate guide surface
200 telescopic arm
201 arms drive motor
202 splined shaft
203 first part of an arm
204 second part
205 sliding chain sprocket,
217 fixed chain sprocket
206 Second obround chain guide
208 stationary toothed rack
207 toothed rack of first part
209 obround chain drive system
210 ball screw or trapezoidal screw
211 linear bearings
212 linear rails
213 screw nut
214 compartment drive motor
215 grippers
216 bearing housing
217 fixed chain sprocket
218 toothed rack on the second part
300 aisle
301 shelving structure
302 warehouse rail structure

What is claimed is:

1. An unmanned shuttle for automated warehouse systems configured to move along warehouse rail, the shuttle comprising:
a first and a second side compartment, each having at least an inner wall and two end walls,
the first side compartment being a motor comprising compartment and housing an arms drive motor, a compartment drive motor, and a wheel drive motor,
the first and the second side compartments being attached to each other via a splined shaft having a first end connected to the compartment drive motor via a fixed chain sprocket attached to a first obround chain guide attached to a bottom part of the inner wall of the first side compartment, and a second end connected to a splined hub attached to a sliding chain sprocket attached to a second obround chain guide attached to a bottom part of the inner wall of the second side compartment, wherein the splined shaft is configured to be rotated by the compartment drive motor and the sliding chain sprocket is configured to simultaneously slide along the splined shaft, while the fixed chain sprocket at the other end of the splined shaft is configured to turn but not slide;
the inner wall of each side compartment comprising a stationary horizontal toothed rack;
two telescopic arms configured to extend in synchrony to two opposite directions;
each telescopic arm comprising a first part and a second part,
the first part comprising a toothed rack along its lower edge and an obround chain drive system mounted on its upper edge at a middle of the length of the first part, said toothed rack being in contact with the first or the second obround chain guide attached onto the bottom part of the inner wall of the first or second side compartment respectively, and the first part being configured to extend upon moving the chain around the obround chain guide via turning the splined shaft,
the second part comprising a toothed rack on its upper edge and the toothed rack being in contact with the obround chain system on the upper edge of the first part, and the second part configured to extend upon moving a chain around the chain guide of the obround chain system via extending movement of the first part,
wherein at least one of the side compartments comprises a horizontal inward extending crate guide surface configured to provide support for a crate positioned on a loading space between the first and second side compartments,
wherein a distance between the first and second side compartments is adjustable via a ball or trapezoidal screw connecting the compartments to each other, and the ball or trapezoidal screw configured to be turned by the compartment drive motor,
and wherein the shuttle has at least one wheel in each end wall of the first and the second compartment and the wheels of the first compartment are connected with a driveshaft and the driveshaft is driven by the wheel drive motor with a belt housed inside the first side compartment.

2. The shuttle system of claim 1, wherein the telescopic arm is configured to extend into two directions perpendicular to driving direction of the shuttle beyond an edge of the loading space and in a fully extended position a length of the arm is more than twice the depth of the loading space.

3. The shuttle system of claim 1, wherein both ends of the second parts comprise a stationary gripper.

4. The shuttle system of claim 1, wherein the telescopic arms have an extension length more than twice the width of the shuttle.

5. A method to transport and store parcels of different sized in an automated warehouse system wherein the method comprises providing the shuttle system according to claim 1, and depending on the size of a parcel to be retrieved by the telescopic arms and transported on the shuttle device a distance between the telescopic arms is adjusted by moving the side compartments closer or further away from each other via the compartment drive motor turning the ball or trapezoidal screw, and by adjusting the extension length of the telescopic arms by the arms drive motor controlling rotation of the splined shaft and thereby extending movement of the first part of the telescopic arms which causes extending movement of the second part.

6. The method of claim 5, wherein the method comprises adjusting the distance between the telescopic arms and the extension length of the telescopic arms such that the arms can simultaneously hold two or more parcels deposited on a same slot in the shelving system.
